(19) United States
(12) Patent Application Publication
(10) Pub. No.: US 2011/0006686 A1
(43) Pub. Date: Jan. 13, 2011

(54) ILLUMINATION SYSTEM AND ILLUMINATION METHOD FOR ELECTRONIC DEVICE

(76) Inventors: Pao-Jean CHEN, Taipei City (TW); Jui-Tsen HUANG, Taipei City (TW)

Correspondence Address: Muncy, Geissler, Olds & Lowe, PLLC, 4000 Legato Road, Suite 310, FAIRFAX, VA, 22033, US

(21) Appl. No.: 12/611,518

(22) Filed: Nov. 3, 2009

(30) Foreign Application Priority Data
Jul. 9, 2009 (TW) 98123251

(51) Int. Cl. H01K 7/04

(52) U.S. Cl. 315/84; 200/310

(57) ABSTRACT

An illumination system includes a detecting unit and an illuminator, wherein the illuminator responds to the detecting unit. In use, the detecting unit can detect whether at least one predetermined program is opened. The illuminator can illuminate a keyboard when the predetermined program is opened. Moreover, an illumination method is disclosed in the specification.

### RELATED APPLICATIONS

This application claims priority to Taiwan Application Serial Number 98123251, filed Jul. 9, 2009, which is herein incorporated by reference.

### BACKGROUND

1. Technical Field

The present disclosure relates to electronic systems, and more particularly, illumination systems and illumination methods for electronic devices.

2. Description of Related Art

With the fast development of the electronics industry and information technology, illuminated keyboards of computers, such as desktop computers or laptops, have become more popular. Conventionally, the keyboard is illuminated unceasingly for shining during the operation of the computer. Thus, a user can clearly look at each key when he or she uses the computer in the dark.

Power consumption is partly due to that the keyboard is illuminated unceasingly during the operation of the computer; particularly, laptops have limited battery power.

In view of the foregoing, there is an urgent need in the related field to provide a novel technique capable of timely illuminating the keyboard. The present disclosure meets this need.

### SUMMARY

In one or more various aspects, the present disclosure is directed to illumination systems and illumination methods for electronic devices, so as to timely illuminate keyboards.

According to one embodiment of the present invention, the illumination system includes a detecting unit and an illuminator, wherein the illuminator responds to the detecting unit. In use, the detecting unit can detect whether at least one predetermined program is opened. The illuminator can illuminate a keyboard when the predetermined program is opened. Thus, the illumination system can timely illuminate the keyboard without unceasing illumination.

According to yet another embodiment of the present invention, the illumination method includes steps as follows. First, whether at least one predetermined program is opened is detected. Then, a keyboard when the predetermined program is opened. Thus, the illumination method can be performed to timely illuminate the keyboard without unceasing illumination.

According to still yet another embodiment of the present invention, the illumination system includes a detecting unit and an illuminator, wherein the illuminator responds to the detecting unit. In use, the detecting unit can detect whether at least one input field is selected. The illuminator can illuminate a keyboard when the input field is selected. Thus, the illumination system can timely illuminate the keyboard without unceasing illumination.

According to another embodiment of the present invention, the illumination method includes steps as follows. First, whether at least one input field is selected is detected. Then, a keyboard is illuminated when the input field is selected. Thus, the illumination method can be performed to timely illuminate the keyboard without unceasing illumination.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE DRAWINGS

The foregoing summary is illustrative only and is not intended to be in any way limiting. In addition to the illustrative aspects, embodiments, and features described above, further aspects, embodiments, and features will become apparent by reference to the drawings and the following detailed description, of which:

FIG. 1 is a block diagram of an illumination system according to one embodiment of the present invention;

FIG. 2 is a pictorial drawing illustrating light-emitting units configured under a keyboard of FIG. 1;

FIG. 3 is a lateral view illustrating the light-emitting units of FIG. 1 configured in a screen;

FIG. 4 is a schematic drawing of a text editor;

FIG. 5 is a flowchart of an illumination method according to another embodiment of the present invention;

FIG. 6 is a block diagram of another illumination system according to yet another embodiment of the present invention;

FIG. 7 is a schematic drawing of a web browser; and

FIG. 8 is a flowchart of another illumination method according to still yet another embodiment of the present invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and/or firmware.

The foregoing detailed description has set forth various embodiments of is the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.). Further, those skilled in the art will recognize that the mechanical structures disclosed are exemplary structures and many other forms and materials may be employed in constructing such structures.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprise or comprising”, “include or including”, “have or having”, “contain or containing” and the like are to be understood to be open-ended, i.e., to mean including but not limited to. As used herein, the term “and/or” includes any and all combinations of one or more of the associated listed items.

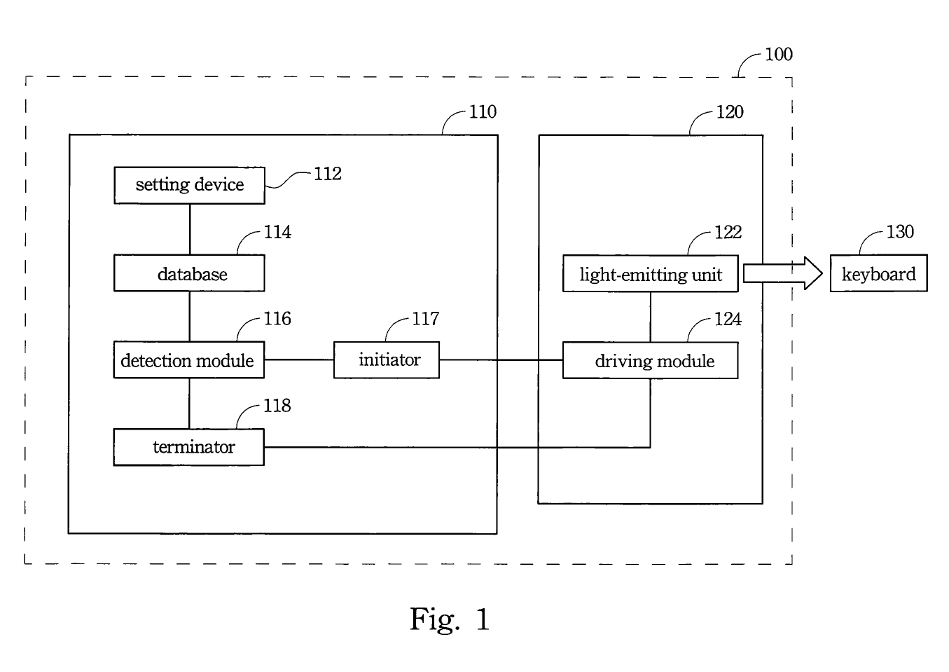

FIG. 1 is a block diagram of an illumination system 100 according to one embodiment of the present invention. The illumination system 100 is adapted for an electronic device, such as a desktop computer, a laptop or the like. For example, a keyboard 130 is configured in the electronic device; additionally or alternatively, the keyboard 130 is electrically connected to the electronic device. In other words, the electronic device may have the keyboard 130.

As shown in FIG. 1, the illumination system 100 comprises a detecting unit 110 and an illuminator 120, wherein the illuminator 110 responds to the detecting unit 120. In use, the detecting unit 110 can detect whether at least one predetermined program is opened. The illuminator 120 can illuminate a keyboard 130 when the predetermined program is opened. Thus, the illumination system 100 can timely illuminate the keyboard 130 without unceasing illumination.

The predetermined program is executed with a text input interface. For example, the predetermined program may be a text editor, office application, a web browser or the like.

Moreover, the illuminator 120 can stop illuminating the keyboard 130 when the predetermined program is closed after the keyboard 130 is illuminated. In practice, the predetermined program isn't executed, which signifies that a user temporarily need not to type by keyboard 130, and therefore the illumination system 100 can stop illuminating the keyboard 130 so as to avoid unnecessary power consumption.

The detecting unit 110 comprises a setting device 112, a database 114 and a detection module 116. In use, the setting device 112 can list the predetermined program in a detection list. The database 114 can store the detection list. The detection module 116 can unceasingly detect whether the predetermined program is opened according to the detection list of the database 114. Thus, users or implementers can edit the detection list on the basis of the selection of one or more programs, so that the keyboard 130 is illuminated when at least one of these programs is executed.

The setting device 112 can be a user interface, so that a user can set the predetermined program by means of the user interface. The illumination system 100 is adapted for the electronic device, and the detection module 116 can be a resident program installed in the electronic device, such as a desktop computer or a laptop; for example, the resident program is loaded to unceasingly detect the state of the predetermined program after the computer has been booted.

The detecting unit 110 comprises an initiator 117; the illuminator 120 comprises at least one light-emitting unit 122 and a driving module 124. In use, the initiator 117 can generate a lighting signal when the predetermined program is opened. The driving module 124 can acquire the lighting signal and drive the light-emitting unit 122 according to the lighting signal, so that the light-emitting unit 122 emits light to the keyboard 130.

While the detection module 116 detects that the predetermined program is opened, the initiator 117 sends the lighting signal to the driving module 124, so that the driving module 124 drives the light-emitting unit 122 to illuminate the keyboard 130.

The detecting unit 110 comprises the terminator 118. In use, the terminator 118 can generate a stop signal when the predetermined program is closed and when the light-emitting unit 122 is still emitting the light to the keyboard 130. The driving module 124 can acquire the stop signal and turn off the light-emitting unit 122 according to the stop signal.

While the detection module 116 detects that the predetermined program is closed, the terminator 118 sends the stop signal to the driving module 124, so that the driving module 124 turns off the light-emitting unit 122.

For example, the driving module 124 may be implemented as a chip or a printed circuit. The initiator 117 and terminator 118 may be implemented as software programs and/or hardware circuits. The light-emitting unit 122 can be an LED element, an electro-luminescence device or the like.

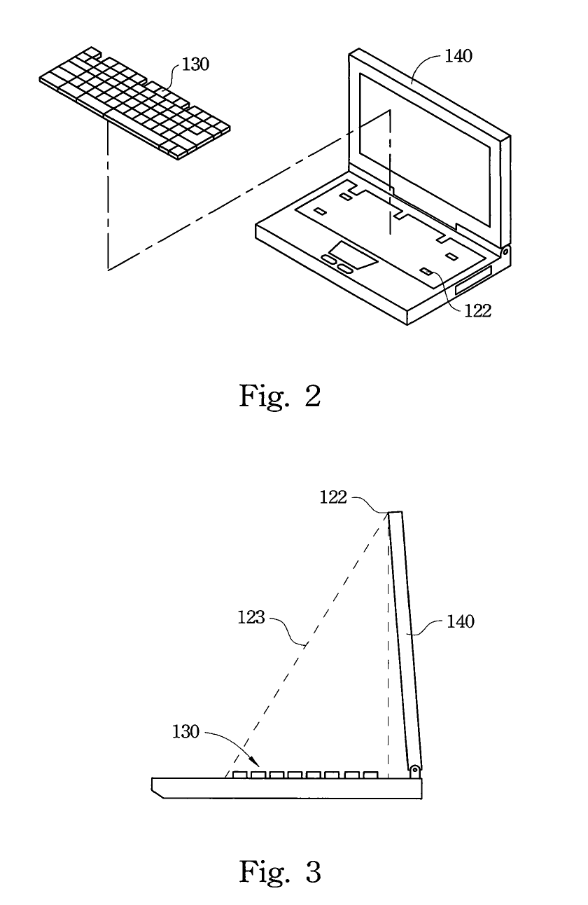

As shown in FIGS. 2 and 3, the above illumination system 100 is adapted for the electronic device having the keyboard 130 and a screen 140; for example, the electronic device is a laptop or the like. In FIG. 2, the light-emitting unit 122 is configured under the keyboard 130; thus, the keyboard 130 is illuminated when the light-emitting unit 122 emits light. In FIG. 3, the light-emitting unit 122 is configured in the screen 140 of the electronic device; thus, the keyboard 130 is illuminated when the light-emitting unit 122 emits light 123.

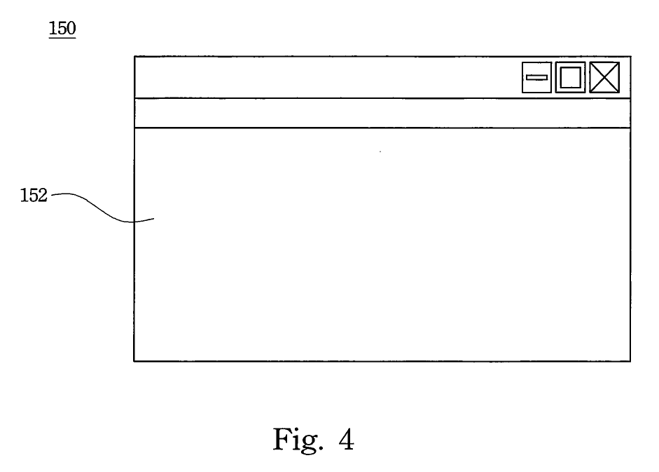

As shown in FIG. 4, the text editor 150 has a text input field 152; the input text field 152 allows character input. The user can edit text in the text input field 152 by using the keyboard when text editor 150 is executed. For example, the text editor 150 may be set as the predetermined program, so that the keyboard is illuminated whenever the text editor 150 is opened.

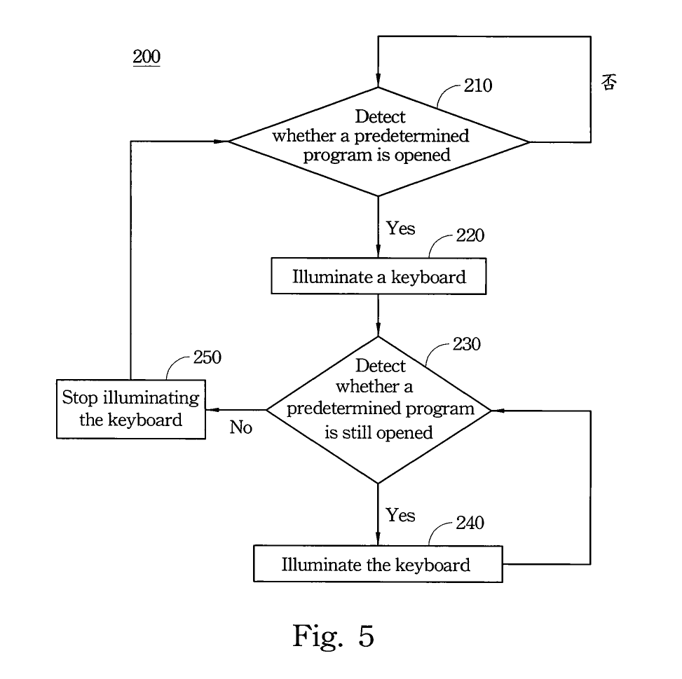

FIG. 5 is a flowchart of an illumination method 200 according to another embodiment of the present invention. The illumination method 200 is adapted for the above electronic device. In the illumination method 200, it should be noted that one step might be performed in series, in parallel, in combination, or otherwise in conjunction with another if the specific order is not described or inferred in the embodiment.

The step 210 in the illumination method 200 is to detect whether at least one predetermined program is opened. The next step 220 is to illuminate a keyboard when the predetermined program is opened. While the predetermined program is still not opened, the step 210 is repeated in an iterative manner. Thus, the illumination method 200 can be performed to timely illuminate the keyboard without unceasing illumination.

After the keyboard is illuminated, the step 230 in the illumination method 200 is to detect whether the predetermined program is still opened. The step 240 is to proceed to illuminate the keyboard when the predetermined program is still opened. On the contrary, the step 250 is to stop illuminating the keyboard when the predetermined program is closed. In practice, the predetermined program isn't executed, which signifies that a user temporarily need not to type by keyboard, and therefore the illumination method 200 can be performed to stop illuminating the keyboard so as to avoid unnecessary power consumption.

In the exemplary embodiment, the predetermined program is listed in a detection list, and whether the predetermined program is opened according to the detection list is unceasingly detected in step 210 and 230. Thus, users or implementers can edit the detection list on the basis of the selection of one or more programs, so that the keyboard is illuminated during at least one of these programs is executed.

In the illumination method 200, a lighting signal is generated in step 210 when the predetermined program is opened; furthermore, the lighting signal is acquired, and light is emitted to the keyboard according to the lighting signal in step 220.

There are at least two modes of emitting light to the keyboard. One is to drive a light-emitting unit under the keyboard, so that the light-emitting unit emits light to the keyboard. The other is the keyboard can be to drive a light-emitting unit in a screen of the electronic device, so that the light-emitting unit emits light to the keyboard. For example, the light-emitting unit is a LED element, an electro-luminescence device or the like.

In the illumination method 200, a stop signal is generated in step 230 when the predetermined program is closed and when the keyboard is still illuminated; furthermore, the stop signal is acquired in step 250 to stop illuminating the keyboard according to the stop signal.

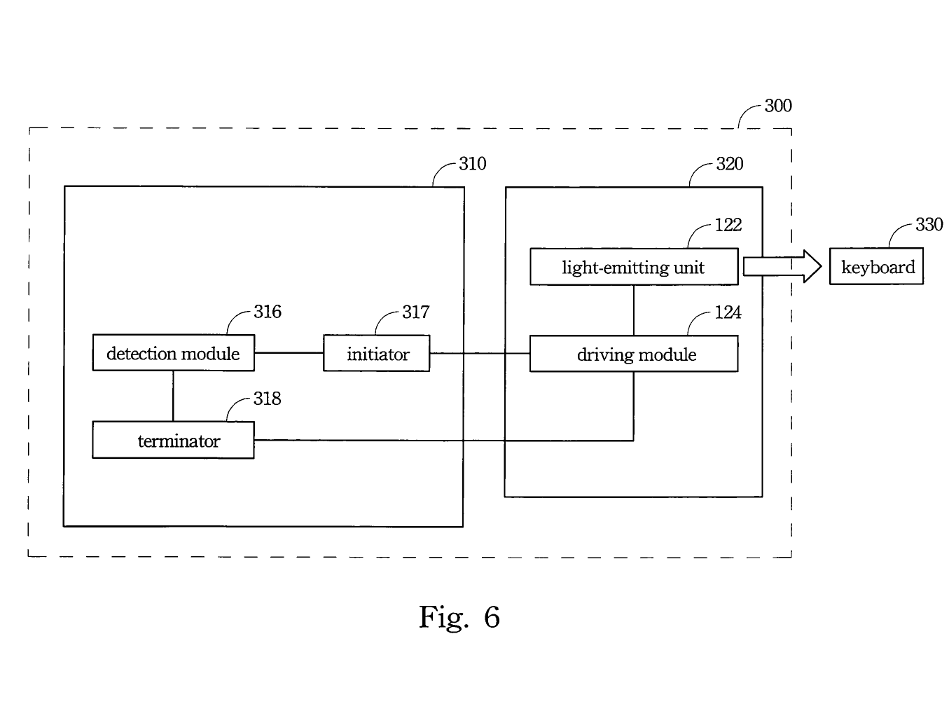

FIG. 6 is a block diagram of another illumination system 300 according to yet another embodiment of the present invention. The illumination system 300 is adapted for an electronic device, such as a desktop computer, a laptop or the like. For example, a keyboard 330 is configured in the electronic device; additionally or alternatively, the keyboard 330 is electrically connected to the electronic device. In other words, the electronic device may have the keyboard 330.

As shown in FIG. 6, the illumination system 300 comprises a detecting unit 310 and an illuminator 320, wherein the illuminator 320 responds to the detecting unit 310. In use, the detecting unit 310 can detect whether at least one input field is selected. The illuminator 320 can illuminate a keyboard 330 when the input field is selected. Thus, the illumination system 300 can timely illuminate the keyboard 330 without unceasing illumination.

The input field allows of character input. For example, the input field may be a text input field of a text editor or office application, a text block in a web page or the like.

Moreover, the illuminator 320 can stop illuminating the keyboard 330 when the input field is not selected after the keyboard 330 is illuminated. In practice, the input field is not selected, which signifies that a user temporarily need not type by keyboard 330, and therefore the illumination system 300 can stop illuminating the keyboard 330 so as to avoid unnecessary power consumption.

The detecting unit 310 comprises a detection module 316 and an initiator 317; the illuminator 320 comprises at least one light-emitting unit 122 and a driving module 124. In use, the detection module 316, for unceasingly detecting whether the input field is selected. The initiator 317 can generate a lighting signal when input field is selected. The driving module 124 can acquire the lighting signal and drive the light-emitting unit 122 according to the lighting signal, so that the light-emitting unit 122 emits light to the keyboard 330.

While the detection module 316 detects that the input field is selected, the initiator 317 sends the lighting signal to the driving module 124, so that the driving module 124 drives the light-emitting unit 122 to illuminate the keyboard 330.

The illumination system 300 is adapted for the electronic device, and the detection module 316 can be a resident program installed in the electronic device, such as a computer; for example, the resident program is loaded to unceasingly detect the selection of the input field after the computer has been booted.

The detecting unit 310 comprises a terminator 318. In use, the terminator 318 can generate a stop signal when the input field is not selected and when the light-emitting unit 122 is still emitting the light to the keyboard 330. The driving module 124 can acquire the stop signal and turn off the light-emitting unit 122 according to the stop signal.

While the detection module 316 detects that the predetermined program is closed, the terminator 318 sends the stop signal to the driving module 124, so that the driving module 124 turns off the light-emitting unit 122. For example, the initiator 317 and terminator 318 may be implemented as software programs and/or hardware circuits.

The keyboard 330 can be the same as the keyboard 130 as shown in FIGS. 2 and 3, and furthermore above illumination system 300 is adapted for the electronic device having the screen 140; for example, the electronic device is a laptop or the like. The light-emitting unit 122 is configured under the keyboard 330; alternatively or additionally, the light-emitting unit 122 is configured in the screen 140 of the electronic device. The light-emitting unit 122 is an LED element or an electro-luminescence device.

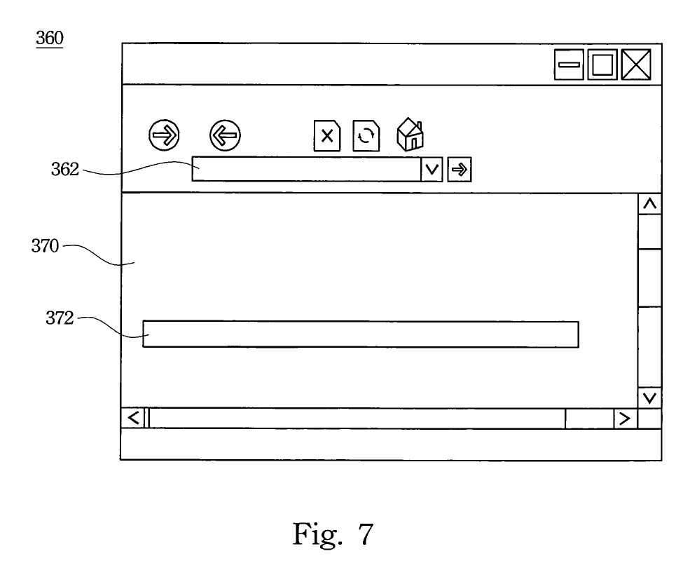

As shown in FIG. 7, the web browser 360 shows the web page 370. The address bar 362 of the web browser 360 and the text block 372 in the web page 370 can service as above input field. Therefore, the keyboard is illuminated whenever the address bar 362 or the text block 372 is selected.

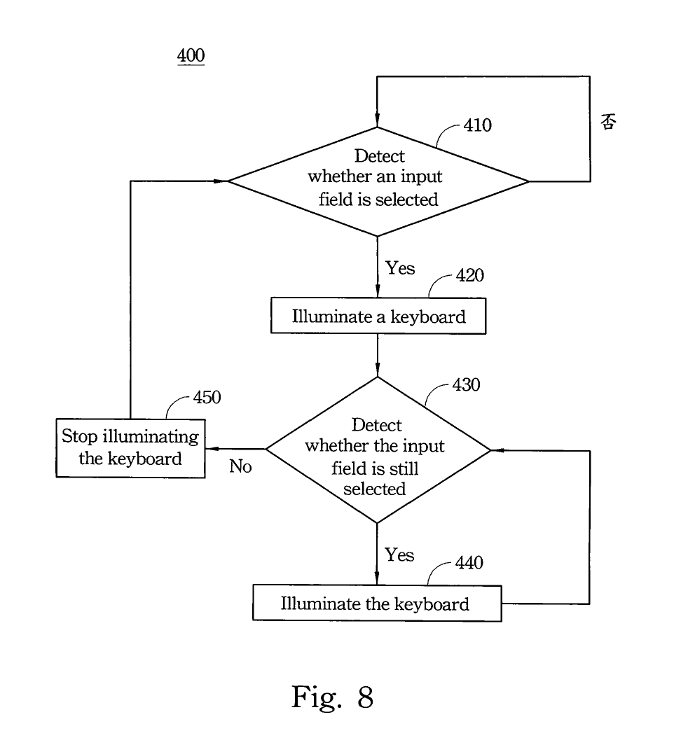

FIG. 8 is a flowchart of another illumination method 400 according to still yet another embodiment of the present invention. The illumination method 400 is adapted for the above electronic device. In the illumination method 400, it should be noted that one step might be performed in series, in parallel, in combination, or otherwise in conjunction with another if the specific order is not described or inferred in the embodiment.

The step 410 in the illumination method 400 is to detect whether at least one input field is selected; the input field allows of character input. The next step 420 is to illuminate a keyboard when the input field is selected. While the input field is still not selected, the step 410 is repeated in an iterative manner. Thus, the illumination method 400 can be performed to timely illuminate the keyboard without unceasing illumination.

After the keyboard is illuminated, the step 430 in the illumination method 400 is to detect whether the input field is still selected. The step 440 is to proceed to illuminate the keyboard when the input field is still selected. On the contrary, the step 450 is to stop illuminating the keyboard when the input field is still selected. In practice, the input field isn't selected, which signifies that a user temporarily need not to type by keyboard, and therefore the illumination method 400 can be performed to stop illuminating the keyboard so as to avoid unnecessary power consumption.

In the illumination method 400, whether the input field is selected is unceasingly detected in step 410 and 430. Moreover, a lighting signal is generated in step 410 when the input field is selected; the lighting signal is acquired, and light is emitted to the keyboard according to the lighting signal in step 420.

There are at least two modes of emitting light to the keyboard in the illumination method 400. One is to drive a light-emitting unit under the keyboard, so that the light-emitting unit emits light to the keyboard. The other is to the keyboard can be to drive a light-emitting unit in a screen of the electronic device, so that the light-emitting unit emits light to the keyboard. For example, the light-emitting unit is an LED element, an electro-luminescence device or the like.

In the illumination method 400, a stop signal is generated in step 430 when the input field isn't selected and when the keyboard is still illuminated; furthermore, the stop signal is acquired in step 450 to stop illuminating the keyboard according to the stop signal.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An illumination system for an electronic device, the illumination system comprising:
a detecting unit for detecting whether at least one predetermined program is opened; and
an illuminator responsive to the detecting unit for illuminating a keyboard when the predetermined program is opened.

2. The illumination system of claim 1, wherein the illuminator stops illuminating the keyboard when the predetermined program is closed after the keyboard is illuminated.

3. The illumination system of claim 2, wherein the detecting unit comprises:
means for listing the predetermined program in a detection list;
a database for storing the detection list; and
means for unceasingly detecting whether the predetermined program is opened according to the detection list of the database.

4. The illumination system of claim 2, wherein the detecting unit comprises means for generating a lighting signal when the predetermined program is opened, the illuminator comprises at least one light-emitting unit and means for driving the light-emitting unit according to the lighting signal, so that the light-emitting unit emits light to the keyboard.

5. The illumination system of claim 4, wherein the detecting unit further comprises means for generating a stop signal when the predetermined program is closed and when the light-emitting unit is still emitting the light to the keyboard, the illuminator further comprises means for turning off the light-emitting unit according to the stop signal.

6. The illumination system of claim 4, wherein said at least one light-emitting unit is configured under the keyboard and/or in a screen of the electronic device.

7. The illumination system of claim 6, wherein the light-emitting unit is a LED element or an electro-luminescence device.

8. An illumination method for an electronic device, the illumination method comprising steps of:
(a) detecting whether at least one predetermined program is opened; and
(b) illuminating a keyboard when the predetermined program is opened.

9. The illumination method of claim 8, further comprising:
(c) stopping illuminating the keyboard when the predetermined program is closed after the keyboard is illuminated.

10. The illumination method of claim 9, wherein the step (a) comprises:
listing the predetermined program in a detection list; and
unceasingly detecting whether the predetermined program is opened according to the detection list.

11. The illumination method of claim 9, wherein the step (a) comprises generating a lighting signal when the predetermined program is opened, the step (b) comprises acquiring the lighting signal and emitting light to the keyboard according to the lighting signal.

12. The illumination method of claim 11, wherein the step (a) further comprises generating a stop signal when the predetermined program is closed and when the keyboard is still illuminated, the step (c) comprises acquiring the stop signal and stopping illuminating the keyboard according to the stop signal.

13. The illumination method of claim 11, wherein emitting light to the keyboard comprises:
driving at least one light-emitting unit for emitting light to the keyboard.

14. The illumination method of claim 13, wherein said at least one light-emitting unit is configured under the keyboard and/or in a screen of the electronic device.

15. The illumination method of claim 14, wherein the light-emitting unit is an LED element or an electro-luminescence device.

16. An illumination system for an electronic device, the illumination system comprising:
a detecting unit for detecting whether at least one input field is selected; and
an illuminator responsive to the detecting unit for illuminating a keyboard when the input field is selected.

17. The illumination system of claim 16, wherein the illuminator stops illuminating the keyboard when the input field is not selected after the keyboard is illuminated.

18. The illumination system of claim 17, the detecting unit comprises means for unceasingly detecting whether the input field is selected and means for generating a lighting signal when the input field is selected, the illuminator comprises at least one the light-emitting unit and means for driving the light-emitting unit according to the lighting signal, so that the light-emitting unit emits light to the keyboard.

19. The illumination system of claim 18, wherein the detecting unit further comprises means for generating a stop signal when the input field is not selected and when the light-emitting unit is still emitting the light to the keyboard, the illuminator comprises means for turning off the light-emitting unit according to the stop signal.

20. The illumination system of claim 18, wherein said at least one light-emitting unit configured under the keyboard and/or in a screen of the electronic device.

21. The illumination system of claim 20, wherein the light-emitting unit is an LED element or an electro-luminescence device.

22. The illumination system of claim 16, wherein the input field allows of character input.

23. An illumination method for an electronic device, the illumination method comprising:
(a) detecting whether at least one input field is selected; and
(b) illuminating a keyboard when the input field is selected.

24. The illumination method of claim 23, further comprising:
(c) stopping illuminating the keyboard when the input field is not selected after the keyboard is illuminated.

25. The illumination method of claim 24, wherein the step (a) comprises unceasingly detecting whether the input field is selected and generating a lighting signal when the input field is selected, the step (b) comprises acquiring the lighting signal and emitting light to the keyboard according to the lighting signal.

26. The illumination method of claim 25, wherein the step (a) further comprises generating a stop signal when the input field is not selected and when the light-emitting unit is still emitting the light to the keyboard, the step (c) comprises acquiring the stop signal and stopping illuminating the keyboard according to the stop signal.

27. The illumination method of claim 25, wherein emitting light to the keyboard comprises:
driving at least one light-emitting unit for emitting light to the keyboard.

28. The illumination method of claim 27, wherein said at least one light-emitting unit is configured under the keyboard and/or in a screen of the electronic device.

29. The illumination method of claim 28, wherein the light-emitting unit is an LED element or an electro-luminescence device.

30. The illumination method of claim 23, wherein the step (a) comprises:
detecting whether the input field allowing of character input is selected.
